(19) United States
(12) Patent Application Publication
(10) Pub. No.: US 2026/0157594 A1
(43) Pub. Date: Jun. 11, 2026

(54) SYSTEM AND METHOD FOR PREVENTION OF ACCIDENTS DUE TO TRIPPING OR BUMPING ON COMMON EQUIPMENT AND OPEN DOORS

(71) Applicant: Vaidyanathan Ramaswami, Branchburg, NJ (US)

(72) Inventor: Vaidyanathan Ramaswami, Branchburg, NJ (US)

(21) Appl. No.: 19/538,354

(22) Filed: Feb. 12, 2026

Related U.S. Application Data
(63) Continuation-in-part of application No. 18/643,604, filed on Apr. 23, 2024, now Pat. No. 12,567,317.
(60) Provisional application No. 63/501,492, filed on May 11, 2023.

(51) Int. Cl. A47L 15/00; A47L 15/42; G08B 7/06

(52) U.S. Cl. CPC A47L 15/0049; A47L 15/4259; G08B 7/06; A47L 2401/26; A47L 2401/34; A47L 2501/26

(57) ABSTRACT

A system and method for detecting an animal and rendering an alarm signal indicating a hazardous condition is detected. The system includes a sensor unit configured to recognize the animal or a moving object and output sensor data. The system includes a controller configured to receive the sensor data, analyze the sensor data, predict a trajectory of the animal or moving object, and predict a hazardous condition based on the analysis of the sensor data. The system includes a warning unit configured to render an alarm signal in response to the predicted hazardous condition.

### CROSS-REFERENCE TO RELATED APPLICATIONS

This application is a continuation-in-part (CIP) of U.S. patent application Ser. No. 18/643,604, filed Apr. 23, 2024, which claims priority to and the benefit of U.S. Provisional Patent Application Ser. No. 63/501,492, filed May 11, 2023, both of which are hereby incorporated herein in their entireties.

### FIELD OF THE DISCLOSURE

The present disclosure relates to an apparatus, a system and a computer-implemented method for preventing accidents due to tripping or bumping on common equipment and open doors.

### BACKGROUND OF THE DISCLOSURE

Equipment used in residential, industrial, or other settings can create obstructions at low heights not in the typical line of sight, thereby causing a risk of tripping and falling. Indeed, many accidents do happen of that type resulting even in major injuries like leg fractures.

According to various estimates, there are approximately 85 million dishwashers in service in the USA alone. There are similarly large numbers of clothes dryers and cooking ranges, with millions of such appliances being sold each year in the USA and elsewhere. These statistics are indicative of the fact that even if the chance of tripping on an open door is very small, the sheer numbers of appliances posing the risk is too large to be ignored.

Although this is well-known, unfortunately presently available equipment does not incorporate safety features to prevent such accidents. This may well be due to the fact that their designs have undergone few major changes and predate some technological advances that have occurred.

There exists an urgent and unmet need for a remediation solution that can prevent accidents due to tripping or bumping on common equipment and open doors.

### SUMMARY OF THE DISCLOSURE

The disclosure provides a novel remediation solution that can prevent accidents due to tripping or bumping on common equipment and open doors. In various embodiments, the remediation solution includes a system or a computer-implemented method comprising one or more electromagnetic energy (EME) transducers that are configured to generate electromagnetic radiation in the portion of the electromagnetic spectrum perceptible to animals such as, for example, humans. The generated electromagnetic radiation can include wavelengths or frequencies that can be sensed by an animal, such as, for example, in the 10 Hz-300 kHz range (preferably between 20 Hz and 20 kHz) for sound signals or 350 nm to 800 nm range for visual signals.

In various embodiments, the EME transducer can include an optical arrangement that can be connected or affixed to common equipment used in residential, industrial, institutional, or other settings, and configured to prevent accidental injuries due to bumping or tripping against retractable structures such as, for example, open doors, retractable furniture, or other residential, industrial, or institutional structures that can extend, retract, or pivot into a pathway of an animal. The EME transducer can include a light emitting diode (LED), a plurality of LEDs, a two-dimensional (2D) array of LEDs, a three-dimensional (3D) array of LEDs, a laser diode, a plurality of laser diodes, a 2D array of laser diodes, a 3D array of laser diodes, or other light emitting device.

In various embodiments, the EME transducer can include one or more gas propulsion devices, including, for example, a fan, a compressor, a compressed gas canister, a nozzle, an array of nozzles, or other gas ejection device, or any combination of the foregoing.

In various embodiments, the EME transducer can include a sound reproducing device such as, for example, a speaker, or a device that can convert electrical signals to sound waves that can be heard or felt by an animal.

In various embodiments, the system and method can include mechanical barriers and the EME transducers can be configured to operate and control the mechanical barriers.

In various embodiments, the system and method can include a detector configured to trigger the EME transducer. The detector can be configured to sense an approaching object and send a detection signal to the EME transducer to reproduce, for example, a sound signal, a visual signal, or activate the mechanical barrier.

The EME transducer can be configured to generate lighting and alarms as well as triggered mechanical barriers such as, for example, mechanical gates.

In various embodiments, the system and method can include fixed or mobile equipment or components. The system can be battery or solar energy powered to support mobile applications.

In at least one embodiment, the system can be retrofitted, or can include equipment or components that can be retrofitted, into existing equipment or structures. The system can include one or more battery operated devices that can be installed or attached (for example, magnetically or through some other means) to such equipment or structures. In at least one alternative embodiment, the system can be built into, or can include equipment or components built into, new equipment or structures.

An embodiment of the disclosure includes a system for rendering an alarm signal when a door of an appliance is in a hazard condition. The system comprises at least one electromagnetic (EME) transducer configured to render an alarm signal when the door of the appliance is in a hazard condition. The at least one electromagnetic (EME) transducer includes at least one of a motion sensor unit, a light emitter unit, a gas ejector unit, and a sound generator, wherein the appliance is a household appliance. The system can comprise a position sensor configured to detect a position of the door of the appliance.

The system can comprise a controller communicatively coupled to the at least one EME transducer and configured to receive a motion detection signal from the motion sensor unit.

The system can comprise a controller communicatively coupled to the at least one EME transducer and configured to send an electronic signal comprising at least one of a light emission signal, a gas ejection signal, or a sound signal.

The system can comprise a controller communicatively coupled to the at least one EME transducer and the position sensor, wherein the controller is configured to send an electronic signal in response to receiving at least one of a motion detection signal from the motion sensor unit and a door position value from the position sensor.

The controller can comprise a driver configured to generate electronic signals to adjust or control one of the motion sensor unit, the light emitter unit, the gas ejector unit, and the sound generator.

In the system, the at least one EME transducer can be provided as an integrated device provided as a single piece that comprises one or more of the motion sensor unit, the light emitter unit, the gas ejector unit, and the sound generator.

In the system, the one or more of the motion sensor unit, the light emitter unit, the gas ejector unit, and the sound generator can be located external to, and separate from, the appliance.

The gas ejector unit can be configured to supply a flow of steam, gas, or particles for reflection of light for visibility as a beam. The gas ejector unit can comprise a fan, at least one nozzle, and a gas supply.

An embodiment of the disclosure includes a computer-implemented method for rendering an alarm signal when a door of an appliance is in a hazard condition. The method includes receiving a door position signal that includes a door position value, determining a hazard condition based on the door position value, generating an electronic signal based on the hazard condition, and sending the electronic signal to at least one electromagnetic (EME) transducer configured to render an alarm signal in response to the received electronic signal. The at least one electromagnetic (EME) transducer includes at least one of a motion sensor unit, a light emitter unit, a gas ejector unit, and a sound generator. The appliance can be a household appliance. The method can further comprise receiving a motion detection signal from the motion sensor unit, wherein the determining the hazard condition is based on the door position value and the motion detection signal. The electronic signal can comprise at least one of a light emission signal that causes the light emitter unit to render one or more light beams in a predetermined beam direction, a gas ejection signal that causes the gas ejector to supply a pressurized gas in a predetermined gas direction, and a sound signal to cause the sound generator to emit a sound. The door position signal can be received from, in response to a signal generated by, an accelerometer or a gyroscopic sensor (also called a gyro sensor). The at least one EME transducer can be an integrated system or device provided as a single piece that comprises the at least one of the motion sensor unit, the light emitter unit, the gas ejector unit, and the sound generator. One or more of the motion sensor unit, the light emitter unit, the gas ejector unit, and the sound generator can be located external to, and separate from, the appliance. The gas ejector unit can be configured to supply a flow of steam, gas, or particles for reflection of light for visibility as a beam. The gas ejector unit can include a fan, at least one nozzle, and a gas supply.

In various embodiments, the system is configured for rendering an alarm signal when a hazardous condition is detected. The system includes a sensor unit configured to detect an animal or a moving object and output sensor data, a controller, and a warning unit. The controller is configured to receive the sensor data, analyze, by one or more machine learning platforms, the sensor data, and predict a hazardous condition based on the analysis of the sensor data. The warning unit is configured to render an alarm signal in response to the predicted hazardous condition. The sensor unit can include a sensor configured to detect a hazard and output second sensor data. The sensor unit can include at least one of an infrared (IR) sensor, an image sensor, and a door position sensor.

In an embodiment, the controller is further configured to receive the second sensor data, analyze the second sensor data, and predict the hazardous condition based on said sensor data and the second sensor data. The sensor unit can include a door position sensor and the hazard is an appliance door.

In some embodiments, the controller is configured to: calculate or predict a trajectory of the animal or the moving object; and/or receive real-time sensor data from said sensor unit, analyze, by the one or more machine learning platforms, the real-time sensor data, and update the calculated or predicted trajectory of the animal or the moving object based on the analysis of the real-time sensor data. The controller can be configured to determine whether the hazardous condition is removed based on the updated trajectory of the animal or the moving object.

The system can be configured to save battery energy by operating only one sensor in the sensor unit before analyzing any sensor data or predicting the hazardous condition. The sensor can include a motion sensor.

In some embodiments, the one or more machine learning platforms are configured to recognize a behavior pattern in the calculated or predicted trajectory of the animal or the moving object and predict a non-hazardous condition based on the behavior pattern. The behavior pattern can include at least one of movement corresponding to loading or unloading an appliance or a machine, movement corresponding to closing a door of an appliance or a machine, and/or movement corresponding to manipulating and removing a hazard.

In various embodiments, the system includes a communication unit configured to: (a) send parametric data to a communicating device and receive either (i) updated parametric data to tune the one or more machine learning platforms or (ii) updated one or more machine learning platforms; or (b) communicate with a mobile app on a smartphone, a tablet, or another communicating device, wherein the system comprises the mobile app.

The warning unit can include at least one of a light emitter, a gas ejector, and a sound generator. The controller can include a driver configured to generate electronic signals to adjust or control at least one of: the infrared (IR) sensor; the image sensor; the door position sensor; a light emitter; a gas ejector; and a sound generator.

In some embodiments, the one or more machine learning platforms include a deep learning model configured to recognize the animal or the moving object.

In some embodiments, the sensor unit includes an accelerometer or gyro sensor.

In an embodiment, the system is constructed as an integrated device. The integrated device can include a system-on-a-chip.

In an embodiment, a computer-implemented method is provided for rendering an alarm signal when a hazardous condition is detected. The computer-implemented method includes: receiving, by a controller, sensor data from at least one of a motion sensor, an image sensor, and a door position sensor; analyzing, by one or more machine learning platforms, the sensor data to predict a hazardous condition; predicting, by the one or more machine learning platforms, the hazardous condition; and sending, by the controller, one or more alarm signals to a warning unit based on the precited hazardous condition. The warning unit can include at least one of a light emitter, a gas ejector, and a sound generator.

Additional features, advantages, and embodiments of the disclosure may be set forth or apparent from consideration of the detailed description and drawings. Moreover, it is to be understood that the foregoing summary of the disclosure and the following detailed description and drawings provide non-limiting examples that are intended to provide further explanation without limiting the scope of the disclosure as claimed.

### BRIEF DESCRIPTION OF THE DRAWINGS

The accompanying drawings, which are included to provide a further understanding of the disclosure, are incorporated in and constitute a part of this specification, illustrate embodiments of the disclosure and together with the detailed description serve to explain the principles of the disclosure. No attempt is made to show structural details of the disclosure in more detail than may be necessary for a fundamental understanding of the disclosure and the various ways in which it may be practiced.

FIG. 1 illustrates an example of an environment having an appliance equipped with a drop-down door.

FIG. 2 illustrates the appliance of FIG. 1 with the drop-down door in an open position and one or more light beams emitted in a predetermined beam direction.

FIG. 3 illustrates the appliance of FIG. 1 with the drop-down door in the open position and one or more light beams emitted in another predetermined beam direction.

FIG. 4 illustrates an embodiment of an obstruction alarm system, according to the principles of the disclosure.

FIG. 5 illustrates an embodiment of an electromagnetic energy (EME) transducer, according to the principles of the disclosure.

FIG. 6 illustrates an embodiment of an alarm controller, according to the principles of the disclosure.

FIG. 7 illustrates an embodiment of an alarm control process, according to the principles of the disclosure.

FIG. 8 illustrates another embodiment of an alarm control process, according to the principles of the disclosure.

The present disclosure is further described in the detailed description that follows.

### DETAILED DESCRIPTION OF THE DISCLOSURE

The disclosure and its various features and advantageous details are explained more fully with reference to the non-limiting embodiments and examples that are described or illustrated in the accompanying drawings and detailed in the following description. It should be noted that features illustrated in the drawings are not necessarily drawn to scale, and features of one embodiment can be employed with other embodiments as those skilled in the art would recognize, even if not explicitly stated. Descriptions of well-known components and processing techniques may be omitted so as to not unnecessarily obscure the embodiments of the disclosure. The examples are intended merely to facilitate an understanding of ways in which the disclosure can be practiced and to further enable those skilled in the art to practice the embodiments of the disclosure. Accordingly, the examples and embodiments should not be construed as limiting the scope of the disclosure. Moreover, it is noted that like reference numerals represent similar parts throughout the several views of the drawings.

The instant disclosure provides systems and methods that can detect and identify hazardous conditions and warn animals in a vicinity of the hazardous condition, including animals that are not, for example, within a line of sight of, or walking toward, the hazardous condition. The hazardous condition can include, for example, an object, a structure, or other obstacle located in a pathway of an animal. The systems and methods are configured to prevent such animal from coming into contact with the hazardous condition such as by unintentionally walking and, in the case of humans, bumping into or tripping over the hazard and falling.

The systems include a variety of sensors that are configured to, among other things: detect or identify a hazardous condition in a pathway of an animal; monitor an area in the vicinity of the hazardous condition; detect and identify animals in the area of the hazardous condition; and predict an animal or a trajectory of any animal in relation to the hazardous condition. The identification of the animal can include recognizing, for example, household member, a child, a pet, or any other animal. The systems also include one or more warning devices configured to generate one or more alarm signals that can alert animals of the hazardous condition. The one or more warning devices can be configured to generate an alarm signal based on the identified animal. For instance, in an embodiment, the system is configured to identify a child and the warning device(s) is configured to generate an audible alarm signal that is in the form of a parental voice command. The hazardous condition can include, for example, a door or other part of an appliance (for example, oven, microwave, toaster, refrigerator, dishwasher, washer, dryer, or the like), or a drawer, a door, or another part of furniture (for example, cabinet, dresser, folding sofa, or the like), other structure (for example, step-down between rooms).

In some embodiments, the variety of sensors include one or more sensors configured to detect or identify the hazardous condition. These one or more sensors can include, any combination of one or more of, for example, a limit switch, magnetic sensor (for example, Hall Effect sensors), infrared (IR) sensors, proximity sensors (for example, capacitive or inductive sensors), rotary encoder sensors, linear encoder sensors, and micro-electro-mechanical sensors (for example, accelerometers or gyroscopes), any of which can be configured to detect a hazardous condition, including, for example, a position sensor configured to detect the position of an appliance door.

In some embodiments, the sensors include one or more sensors configured to monitor an area within a vicinity of the hazardous condition. The sensors can include any combination of one or more of, for example, an image sensor, an image sensor array, an infrared (IR) sensor, a passive IR (PIR) sensor, an ultrasonic sensor, a thermal camera, an IR camera, a radar sensor, a Light Detection and Ranging (LiDAR) sensor, a microphone array, or other detector device capable of detecting an animal, such as, for example, a human or other mammal, including movement of the animal.

In some embodiments, the systems include one or more machine learning (ML) platforms, including, for example, one or more supervised machine learning systems and/or one or more unsupervised machine learning systems configured (for example, built and/or trained) to detect and identify animals in the area of the hazardous condition and/or predict a trajectory of any animal in relation to the hazardous condition. In certain embodiments, the ML platform(s) include one or more of, for example, a deep neural network, a convolutional architecture for fast feature embedding (CAFFE), an artificial neural network (ANN), a convolutional neural network (CNN), a deep convolutional neural network (DCNN), region-based convolutional neural network (R-CNN), ViTs (Vision Transformers), you-only-look-once (YOLO), a Mask-RCNN, a deep convolutional encoder-decoder (DCED), a recurrent neural network (RNN), a neural Turing machine (NTM), a differential neural computer (DNC), a support vector machine (SVM), a deep learning neural network (DLNN), Naive Bayes, decision trees, logistic model tree induction (LMT), NBTree classifier, case-based, linear regression, Q-learning, temporal difference (TD), deep adversarial networks, fuzzy logic, K-nearest neighbor, clustering, random forest, rough set, Kalman filters, autoencoders, denoising neural networks, or a machine learning platform capable of supervised or unsupervised learning. The ML platform(s) include one or more ML models configured (built and/or trained) to detect and identify a hazardous condition, including distinguishing between a hazardous and non-hazardous condition after analyzing animal activity such as, for example, velocity (speed and direction), trajectory (the path followed by the animal), and changes in velocity or trajectory.

In some embodiments, the ML model can include one or more parametrized models, including, for example, a curve in the plane for location as a function of time represented by each of the coordinates (x, y) as a quadratic or some such closed form function of time t. The ML model can be developed, trained, and tested (for example, in-situ or on a remote artificial intelligence (AI) platform such as Vertex AI) to compute and/or predict collision probabilities based on sensor data. In an embodiment, the ML model is implemented in firmware in the controller. Periodically, as data accumulate, the ML model(s) (including feature sets and algorithms) can be refined or tuned in-situ or on a remote platform such as a cloud platform, in which case the revised model(s) and thresholds can be downloaded into the controller. In the latter case, data gathered in the system can be pushed to the remote platform, and periodic updates can be made to the ML models.

In some embodiments, the warning device can include one or more alarm devices configured to generate an alarm signal, such as, for example, an auditory signal, a visible signal, an olfactory signal, a tactile signal, a pneumatic signal, or other sensory-inducing signal that can alert an animal of a hazardous condition. The alarm signal can be customized to the animal (for example, adult person, child, or pet) for optimal effect.

The system can include a battery powered apparatus that is configured to operate the one or more sensors and alarm device(s) sparingly so as to conserve battery power. In various embodiments, the apparatus operates one or more motion sensors connected to a controller to conserve power. In some embodiments, in addition to the detection of a hazard condition (for example, a dishwasher door being left open), alarms are triggered only when motion is detected in the vicinity of the hazardous condition.

In certain embodiments, the system includes an ML platform having one or more machine learning models built and/or trained to discern a hazardous condition from a non-hazardous condition to avoid generating false alarms, which might be annoying to people and other animals. For example, during the loading/unloading phase of a dishwasher, while there is bound to be motion nearby, it would be annoying to the user if repeated loud sounds or flashing lights are rendered. The system includes a ML model configured (for example, built or trained) to differentiate between a hazardous and a non-hazardous condition, such as, for example, an open door with real-time activities associated with loading and unloading versus someone walking in the path of the open door. For instance, in some embodiments the ML model is trained to perform a mean cluster analysis of some features such as the distances traversed by the user or the number of changes of direction in one or more intervals of time and recognize a hazardous or non-hazardous condition based on the analysis. The ML model can be configured (built and/or trained) to analyze activities and perform gesture recognition where, for instance, the ML model is trained to analyze sensor data (such as, for example, image data from a camera) and recognize hand movements associated with a non-hazardous condition such as loading/unloading versus a hazardous condition such as swinging of the arms, say, of someone walking or of a child running.

In certain embodiments, the system includes a communication unit configured to communicate with one or more communication devices, including, for example, wearable devices with Bluetooth. In some embodiments, the communication unit is configured to pair with the communication device (for example, wearable device) so that an alarm signal is generated only when an individual is nearby using the strength of the Bluetooth signal as a proxy for proximity. This way, the alarm only goes off when someone is nearby and is not an annoying alarm that draws too much battery charge. In some embodiments, data in the form of video clips available in various collections can be used to build training datasets, particularly to learn about noisy and high use environments such as a laboratory.

In certain embodiments, the system is configured to discern between a hazardous and non-hazardous condition by monitoring and calculating (or predicting) a trajectory of the animal in relation to a hazard. For example, the system is configured to detect and/or calculate (or predict) the trajectory of a moving animal (such as, for example, an individual walking or otherwise moving in a direction parallel to the hazard such as when going from one room to another using a pathway that is adjacent to a step down) and predict a hazardous condition based on the trajectory. For instance, the system can detect and/or calculate a trajectory and predict a non-hazardous condition, such as, for example, in a kitchen where one may be walking in a direction parallel to the dishwasher and away from its door.

In some embodiments, the system is configured to either compute (for example, by the controller) probabilities of collision based on time series data of coordinates of locations of the animal in relation to the hazard or predict (by the ML model) a trajectory of the animal in relation to the hazard. The system can be configured to collect time series data and/or analyze sensor data and compute or identify parameters of an animal's movement, including velocity and any change in velocity, such as, for example, acceleration/deceleration and/or change in direction, and predict the trajectory, including velocity and path, of the animal with respect to the hazard. The term “velocity” includes both a speed value and a direction value, each as a function of time. The system can be further configured to calculate or predict collision probabilities within various time thresholds and determine when an alarm condition exists and to trigger the alarm. Training datasets for ML models can be derived from image data collected from cameras over time and annotated for training computer vision models for object identification, detection, and motion prediction.

In some embodiments, TensorFlow and PyTorch libraries can be used to train or build training datasets for the ML models. The ML models can be trained to classify different environments or equipment. For example, ML models can be trained to discern between an oven door in a home and one in a pizza shop, since the frequency of use of an oven door in a home is far less and sparse compared to that in a pizza shop. Different doors may also be open for different lengths of time. Information such as, for example, frequency, timing, rate of closure, among other things, can be used to annotate collected data and build training datasets. An initial training dataset can be built by placing a required set of devices in specific environments (homes, hospitals, laboratories, pizza kitchens for instance), collecting data, and annotating the collected data to create one or more training datasets. A unique training dataset can be created for each specific environment, which can then be used to train the ML models to learn and identify hazardous and non-hazardous conditions based on received sensor data, such as, for example, IR sensor data, image data, and sound data.

In some embodiments, the system is provided as a computer-on-a-chip, system-on-chip (SoC), or a single-board computer, comprising a controller, one or more sensors, and one or more warning devices.

In certain embodiments, the system includes one or more ML models built and/or trained to discern hazardous/non-hazardous conditions in “noisy” environments, such as, for example, commercial or industrial settings like a hospital or a laboratory, where a hazard may exist and many people may walk or move around the hazard, although not in any way that presents any endanger. The ML models are trained to remove or ignore noisy conditions such as, for example, motion or trajectories that, with respect to the hazard, have a near-zero probability of the individuals coming into contact with the hazard. In some embodiments, the warning device may use directional elements so as to alert only specific regions or areas of a space or vicinity.

In the various embodiments, the system includes a controller that is intelligent and that not only listens to sensor data from one or more sensors but also is able to classify each motion with high accuracy as one that deserves an alarm based on one or more predetermined conditions. In at least one embodiment, the system includes a hybrid approach where the ML models are contained locally in the system and ML data and computation-intensive training and testing are performed in a remote ML platform, such as, for example, a suitable cloud platform. The ML models can be built, trained, and tested on the remote platform, including selection of simplified features and algorithms that can be implemented in the ML models. The system can be configured, under control of the controller, for periodic updates to keep the ML models in the system current, taking advantage of collected data stores and recent cloud-based computations and updates.

The system can be implemented in a variety of environments, including, for example, a system equipped with: a loud alarm for a user who is hearing impaired and in need of a louder alarm; an alarm with a voice generator configured to produce commands in a parent's (or other individual's) voice such as for child users who may respond to a command in a parent's own voice rather than to a beeping sound, and the former may serve as a better alarm than the latter; an audible alarm where the user is an epileptic person who may suffer a seizure from certain types of alarms like a blinking light which may need to be turned off just for such a person; object recognition so that when the approaching object is a robot, the system can communicate with the robot with pre-determined signals, avoiding generation of any audible or visual alarm signals.

In some embodiments, the system includes an intelligent controller capable of implementing common protocols like DDS (Data Distribution Service) used by robot industry standards such as ROS (Robot Operating System) or ROS2.

In the case of a hazard like an open dishwasher door, in some embodiments the system includes a plurality of sensors to detect and discern different types of objects. For instance, the system may include an IR sensor to detect motion and a heat sensor configured to differentiate between a living object and a robot. In an embodiment, the IR sensor can be configured to detect both motion and whether the object is a living object or a robot by, for example, analyzing the heat signature of the object. Also, the system can include sensors configured to detect and identify specialized feature sets, such as, for example, those characteristic of feet and legs of specific types of pets like cats and dogs, or features that can differentiate or identify an adult or a child from limited measurements of only a part of the object. The ML models can be trained to detect and identify the specialized feature sets by building training data sets that can be used by the ML models to learn the feature sets and, after training, recognize objects using limited computing power.

In some embodiments, the system includes one or more integrated sensor modules, each equipped with a camera (for example, 2MP), motion sensor, microphone, distance sensor, Wi-Fi/Bluetooth, and a processor for on-device ML. In an embodiment, the integrated sensor module includes an Arduino board, such as, for example, the Arduino Nicla Vision, for machine vision tasks, enabling the system to see, process images, recognize objects (for example, body parts, movements, gestures, colors), and make decisions locally without connection to remote computing devices (for example, without a cloud connection). The integrated sensor modules can be operated to analyze video data and recognize objects and hazardous conditions by classifying objects and hazards in different environments where the system may be used.

The positioning of the system in an environment can affect the sensitivity and range of the sensors and warning devices. Similarly, the layout and configuration of the environment can affect the system's performance. For example, a dishwasher equipped with the system whose optical field of view is blocked by a structure such as a center island in the kitchen can be configured to automatically inhibit generating an alarm signal when someone walks on the other side of the structure, compared to the system operating in an environment without such a structure.

In some environments, a system mounted at a lower level of the dishwasher may have a larger optical field of view compared to one mounted at the top, such as when the dishwasher is in the open position.

In some embodiments, the system can be configured to automatically equalize its settings to the particular environment in which the system is installed or affixed. The system can include pre-sets for different environments. The system can be configured to automatically find an optimal position in the environment, such as, for example, on a dishwasher door, and facilitate optimal installation of the system in the environment, such as, for example, by notifying the installer of the optimal position with differing sound levels, with the optimal position indicated by the loudest sound value. The system can be configured to fine-tune its sensors and warning devices to provide sensor data and alarm signals having optimal efficacy in sensing objects and their movements and directing an alarm signal in the direction of the object or movement.

In some embodiments, the controller is configured to manage operation of multiple sensors and provide cooperative controls so that conflicting messages are not generated by different sensors.

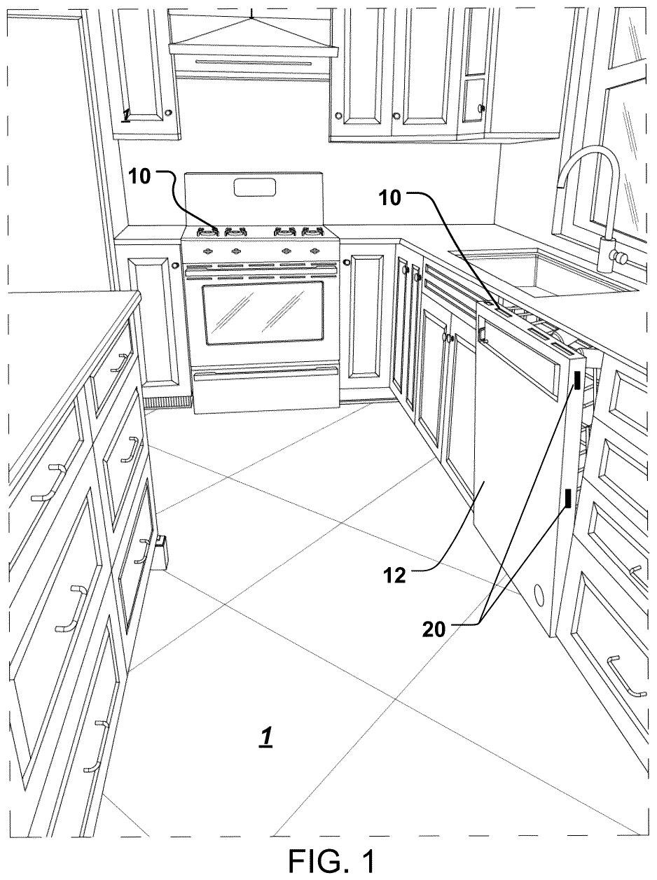

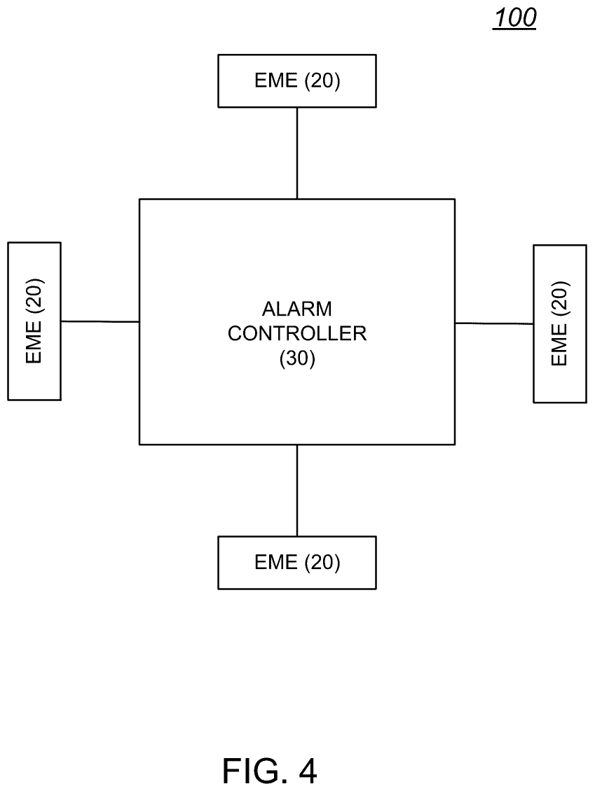

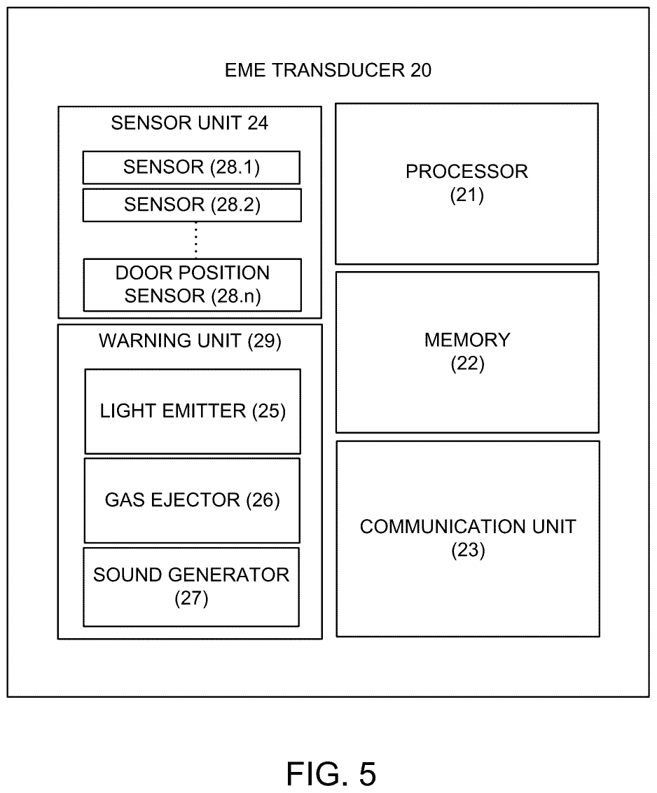

FIG. 1 shows a non-limiting example of an environment 1 having one or more appliances 10, at least one of which is equipped with a door 12. The appliance 10 can be equipped with a door 12 comprising, for example, a side-wise opening door, a drop-down door, or a pull-up door. The appliance 10 can be equipped with one or more electromagnetic energy (or EME) transducers 20 (shown, for example, in FIG. 5). The appliance can be equipped with, or connected to, an obstruction alarm (OA) system 100 (shown, for example, in FIG. 4), including an alarm controller 30 (shown in FIG. 4) and the one or more EME transducers 20. The EME transducers 20 (and OA system 100) can be located on or near any suitable part of the appliance 10, including, for example, on the front, side, or an inner part of the door 12.

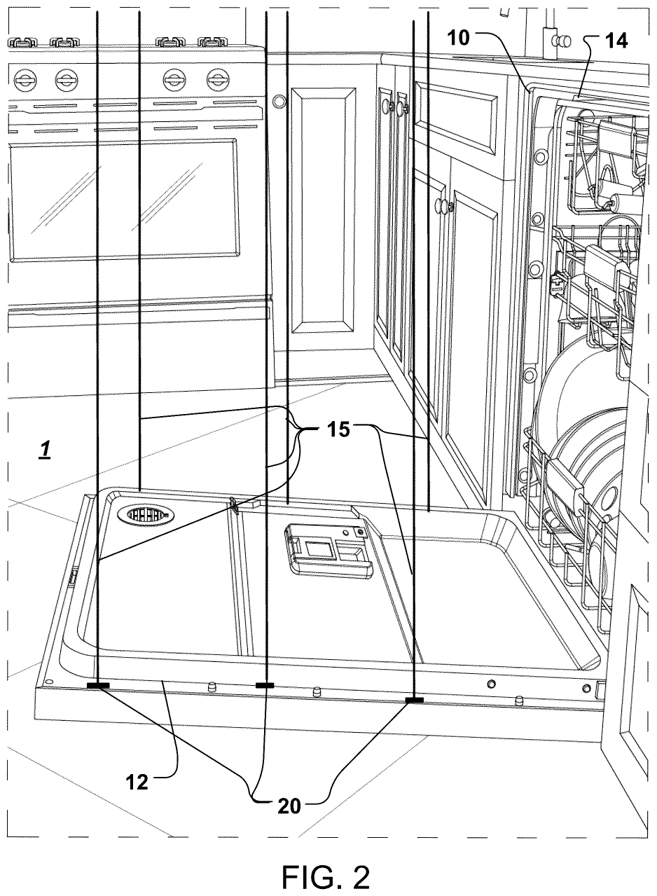

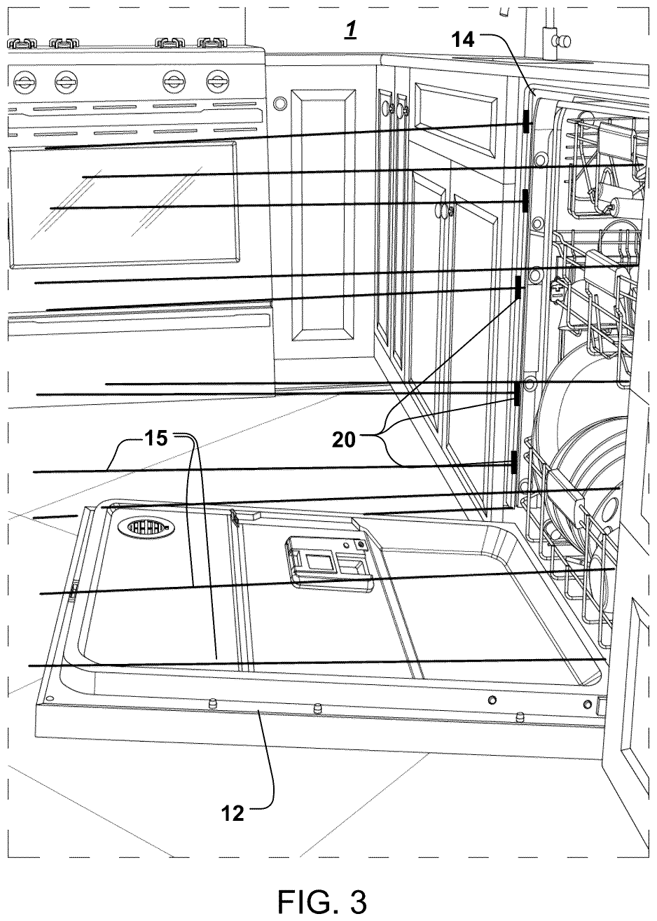

FIGS. 2 and 3 illustrate the appliance 10 with the door 12 in an open position and equipped with light beams 15 emitted in different beam directions. The appliance 10 includes one or more EME transducers 20, each of which can be configured to emit one or more light beams 15 in one or more predetermined beam directions. The EME transducers 20 can be configured for installation in the door 12 and/or the body 14 of the appliance. In certain embodiments, the EME transducers 20 can be configured to be attached to a surface, such as, for example, on the door 12, the body 14, or another surface, separate from the appliance 10, such as, for example, on another appliance, a nearby structure, a wall, a ceiling, or a floor sufficiently near the appliance 10 to generate a warning signal within or near to the pathway that might be obstructed by the door 12 when open. The EME transducers 20 can be configured to communicate with each other via one or more communication links.

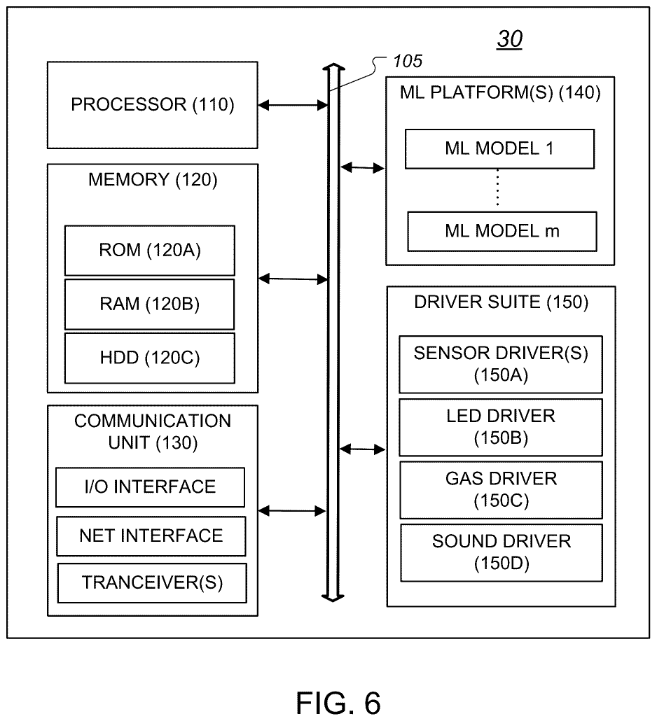

Referring to FIGS. 2 and 3, the EME transducers 20 can be installed in the door 12 and the body 14, respectively, and configured to emit one or more light beams 15 in one or more predetermined beam directions. As seen in FIG. 2, the EME transducers 20 can be configured to emit one or more light beams 15 from the door 12 in a beam direction that is substantially perpendicular to an inner surface of the door 12, which can be substantially parallel to the gravity vector when the door 12 is in the drop-down open position. In some embodiments, the beam direction can be adjustable, such as, for example, in response to a control signal from a controller (for example, controller 30 shown in FIG. 6). The beam direction can be varied based on, for example, an identified motion or an identified moving object.

In an embodiment according to FIG. 3, one or more of the EME transducers 20 are installed in the body 14 of the appliance 10 and configured to emit one or more light beams 15 from the body 14 in a beam direction that is substantially perpendicular to the gravity vector. In some embodiments, the beam direction can be adjustable and varied at an angle other than 90-degrees (for example, with respect to the gravity vector), such as, for example, greater or less than 90-degree, depending on the identified motion or identified moving object.

In various embodiments, the EME transducers 20 can be installed at various locations on or in the appliance 10, such that when the door 12 is open, one or more light beams 15 are emitted to alert a user or any animal in the vicinity of the open condition of the door 12. The EME transducers 20 can be configured to emit the light beams 15 in response to the door 12 opening and/or in response to detecting motion, such as, for example, a person or other animal approaching the appliance 10 or door 12.

As noted earlier, the EME transducer 20 can be configured for drop-down doors, pull-up doors, or side-wise opening doors that, when open, can obstruct or block passageways fully or partially, thereby obstructing a pathway and posing a risk to those traveling in the pathway.

In various embodiments, where warning is through a light beam, the EME transducer 20 can be augmented by, or to include, a system providing a flow of steam, gas, or particles for reflection of the light for visibility as a beam. In such cases, the system 100 can incorporate appropriate storage compartments for the emitted material as also a fan and nozzles to emit the material in a predetermined gas direction and amount.

In various embodiments, the system 100 (shown, for example, in FIG. 4), including EME transducer 20 (shown, for example, in FIG. 5) and controller 30 (shown, for example, in FIG. 6) can be implemented with appliances or equipment in other environments, including for example, residential, commercial, industrial, institutional, or other common environments that can benefit from alerting humans or other animals travelling in trajectories or pathways that might be obstructed by a moveable part such as, for example, a door, a window, a swing gate, a step-up stool, drop-down furniture (for example, desk, sofa, bed, or stool), or saw-horses with drop-down areas for placement of tools and accessories, as will be understood by those skilled in the art.

Referring to FIGS. 2, 3 and 4, the system 100 can include a plurality of EME transducers 20 that can be installed in, or attached to, and configured to emit beams 15 from the door 12 and/or the body 14 of the appliance 10 in a predetermined direction; such as, for example, a direction that is perpendicular (or at an angle greater or less than 90-degrees) to an inner plane of the drop-down door 12, as seen in FIG. 2, or a direction that is perpendicular (or at an angle greater or less than 90-degrees) to a perimeter of the opening of the appliance as seen in FIG. 3, or any door position value (for example, an angle relative to the gravity vector) therebetween to optimize visibility of the light beams in the pathway blocked by the open door 12 to alert oncoming animals.

FIG. 5 shows a nonlimiting embodiment of the EME transducer 20. The EME transducer 20 can include at least one of a processor 21, a memory 22, a communication unit 23, a sensor unit 24, and a warning unit 29. The sensor unit 24 includes a plurality of sensors 28.1 to 28.n (where n is an integer greater than 1), including a motion sensor 28.1 and a door position sensor 28.n. The warning unit 29 includes a plurality of warning devices, including a light emitter 25, a gas ejector 26, and a sounder generator 27. Any one or more of the components 21 to 28 can be communicatively coupled to each other and/or to an external controller (such as, for example, the controller 30 shown in FIGS. 4 and 6) via one or more communication links.

In various embodiments, the sensors 28.1 to 28.n include limit switches, magnetic sensors (for example, Hall Effect sensors), proximity sensors (for example, capacitive or inductive sensors), rotary encoder sensors, linear encoder sensors, and micro-electro-mechanical sensors (for example, accelerometers or gyroscopes), any of which can be configured to detect a position or movement of an object or structure such as, for example, a door of an appliance.

In certain embodiments, the EME transducer 20 includes only the warning unit 29. In those embodiments, the sensor unit 24 is located separately from, or included in, the controller 30, and controller 30 is communicatively coupled to the EME transducer 20.

The alarm controller 30 is configured, in various embodiments, to operate as discussed above, including to: receive sensor data; detect or identify a hazardous condition; monitor an area in the vicinity of the hazardous condition; detect and identify animals in the area of the hazardous condition; and predict an animal or a trajectory of any animal in relation to the hazardous condition. The alarm controller 30 is further configured in those embodiments to discern between a hazardous condition and a non-hazardous condition and operate one or more warning devices to generate alarm signals that can alert animals of the hazardous condition. In an embodiment, the controller 30 is configured to send data to a communicating device (not shown) such as a cloud server to build, train, and/or tune one or more ML models on the communicating device and download the updated models from the communication device to the controller 30.

The EME transducer 20 can be configured as an integrated warning device provided as a single device and comprising at least one of the components 21-28. In various embodiments, any one or more of the components 21-28 can be provided as a unique sensor device or warning device that is physically separate from the remaining components, which in turn can be provided in a single integrated warning device or as multiple distinct devices.

In some embodiments the EME transducer 20 includes the sensor unit 24, the warning unit 29, the processor 21, the memory 22, the communication unit 23, the ML platforms 140 (shown in FIG. 6), and the driver suite 150 (shown in FIG. 6). In an embodiment, the ML platforms 140 are included in the memory 120 and can be accessed and run by the processor 21.

In some embodiments, the processor 21 includes an application specific integrated circuit (ASIC) or a microprocessor (μP). The processor 21 can be endowed with Artificial Intelligence and Deep Learning capabilities (for example to determine if an oncoming animal is an adult, a child, or a pet).

The memory 22 includes a non-transient computer storage that can be configured to store data and executable computer program instructions, including computer program code executable by the processor 21.

The communication unit 23 includes a transmitter and a receiver configured to send and receive data and instruction signals. The communication unit 23 can include one or more transceivers, input-output (I/O) interfaces, or a network interface. The communication unit 23 is configured to send and receive data and/or instruction signals via one or more communication links to/from an external communication device, such as, for example, the controller 30 (shown, for example, in FIGS. 4 and 6). The data and instruction signals can include, for example, motion detection signals, light emission signals, gas ejection signals, or sound generation signals.

The sensor unit 24 can include, for example, at least one of an infrared (IR) sensor and an image sensor configured to detect motion in an area within a predetermined distance from the sensor unit 24. In various embodiments, the sensor unit 24 is configured to be adjustable, so that the motion detection area can be adjusted to detect motion within a radius of, for example, two feet, three feet, four feet, five feet, or greater. The sensor unit 24 can be configured to generate and send sensor data to the processor 21 or, in some embodiments, a communicating device such as the controller 30 (shown in FIG. 6). The sensor data can be processed by the processor 21 (or controller 30) to analyze the sensor data, detect an animal, and calculate or predict a trajectory of motion by the animal with respect to the sensor unit 24 or another predetermined location. The processor 21 or controller 30 can be configured to recognize the animal, including any body part (for example, fingers, hand, arm, leg, torso, or head) of the animal and, in certain embodiments, track the motion of the body part to discern between a hazard condition and a non-hazard condition, such as, for example, when a user opens a dishwasher door to load or unload the machine.

In an embodiment, the sensor unit 24 is configured to communicate with a sensor driver 150A (shown in FIG. 6), which can provide range sensitivity signals to adjust and set a distance range for detection of motion by the sensor unit 24.

The light emitter 25 can include a light source, a light (or laser) emitting device (LED), a plurality of LEDs, an array of LEDs, a plurality of LEDs, or a display. The LEDs can include different colors that are assigned to different warning conditions such as, for example, a green light beam for a door 12 that is nearly completely closed and a red light beam when the door 12 is nearly completely open. The display can include a video display, a holographic display, or other device capable of displaying a visible signal.

In an embodiment, the light emitter 25 is configured to communicate with an LED driver 150B (shown in FIG. 6), which can provide instruction signals to operate and control the light emitter 25.

The gas ejector 26 can include one or more gas ejection nozzles (not shown), a valve (not shown), and a pressurized gas (not shown), such as, for example, stored a gas supply line (not shown) and a tank (not shown). The valve is configured to open or close based on a driver signal, such as, for example, a signal received from the gas driver 150C (shown in FIG. 6).

In an embodiment, the gas ejector 26 is configured to communicate with the gas driver 150C, which can provide instruction signals to operate and control the gas ejector 26.

The sound generator 27 can include a speaker or other device capable of producing a sound. In an embodiment, the sound generator is configured to communicate with the sound driver 150D (shown in FIG. 6), which can provide instruction signals to operate and control the sound generator 27.

Any one or more of the sensor unit 24, light emitter 25, gas ejector 26, and sound generator 27 can be communicatively coupled to the processor 21, the memory 22, and/or the communication unit 23 by one or more communication links.

The door position sensor 28.n can include, for example, an accelerometer, a gyroscopic sensor, an electromagnetic ball switch, a contact sensor, a magnetic contact sensor, a reed switch sensor, an optical sensor, a motion sensor, an IR sensor, a linear variable differential transformer (LVDT), a piezoelectric sensor, a string potentiometer (or cable position transducer), a capacitive displacement sensor, a position encoder, or a device capable of detecting the position of the door 12, such as, for example, with respect to the body 14, and generating a position signal corresponding to the position of the door 12.

In certain embodiments, the door position sensor unit 28.n is configured to communicate with the processor 21 and/or the processor 110 (shown in FIG. 6), including generating and sending a door position signal to the processor 21 or the processor 110.

In various embodiments, at least one of the sensor unit 24 (including the door position sensor 28.n) and the warning unit 29 (including the light emitter 25, gas ejector 26, sound generator 27) are communicatively coupled to a communicating device such as the controller 30 (shown in FIG. 4 or 6) via the communication unit 23 and one or more communication links.

The light emitter 25 can be configured to add one or more lights that can emit or scan a beam from an obstruction, such as, for example, the door 12, all the way up, down, or sidewise as needed so as to be visible to a standing or approaching person or animal. The light emitter 25 can be configured to emit or scan a light beam selected to have any color in the visible spectrum, including different colors designated for different conditions (such as, for example, a red beam for a door that is fully open and a blue or green beam for a door that is only partially open).

In certain embodiments, the EME transducer 20 can include an actuator (not shown) configured to actuate and operate an article, such as, for example, a pole that pops up or sidewise in the line of vision to warn an animal when the door 12 is in the open position. The actuator (not shown) can include a motor, a step-motor, a hydraulic actuator, or other device capable of moving the article.

In an embodiment, the EME transducer 20 can be configured to generate forced or pressurized air via the gas ejector 26, where the air can be directed toward and forced at the animal from below so as to force the animal to look down immediately and be forewarned of the danger. The gas ejector 26 can be configured to generate and direct forced air to create virtual reality.

In various embodiments, the light emitter 25 can include a lighting arrangement configured as a permanent fixture or a removable one. The latter can be particularly useful for mobile applications where, for example, repairmen and carpenters may carry foldable equipment that they can unfold for use in work locations. Such equipment can have protruding parts to hold tools and other accessories that may be low and below the line of sight, thereby presenting an imperceptible or easily overlooked obstruction to a person traveling in the direction of the protruding part.

In various embodiments, the EME transducer 20 and/or the system 100 can include a power source to supply power to the various components therein. For instance, the EME transducer 20 can include a battery to supply power to any one or more of the components 21 to 28. In at least one embodiment, the system 100 includes a power source that supplies power to the alarm controller 30 and each EME transducer 20. The power source can include, for example, an alternating current (AC) power supply (for example, 110V or 220V), a transformer, a battery, a solar power supply or other source of electric power.

In certain embodiments, the sensor unit 24 can be configured on a portion of, for example, the door 12 or body 14, such as, for example, on a front (or inner) surface of the door, or on either or both side portions of the door 12, a top portion of the door 12, or anywhere along the perimeter of the door 12 or body 14, including around the entirety of the perimeter of the door 12 or body 14. The sensor unit 24 can include, for example, an infrared (IR) sensor, an optical sensor, an image sensor, or any other sensor capable of detecting motion of an animal or thing along a pathway leading to the obstruction, such as, for example, a door in an open or partially open position.

In an embodiment, the EME transducer 20 can be configured to reproduce a light or light beams (via the light emitter 25) augmented by an audio alarm, such as, for example, a beeping sound (via the sound generator 27) and/or gas ejection (via the gas ejector 26), and further configured to detect motion (via the sensor unit 24) in harmful directions. The EME transducer 20 can be configured to generate a door position signal (via the door position sensor 28.n) that includes a door position value indicative of the status of the door 12, including an angular position of the door 12 with respect to the gravitational vector or a plane of the body 14, such as, for example, an angle between 0-degrees and 90-degrees. The angular position can be the angle between a longitudinal axis or a surface plane of the door 12 and a longitudinal axis or surface plane of the body 14, which can be substantially parallel with the gravitational vector.

In various embodiment, the EME transducer 20 can be placed in various areas of equipment where the lights and/or audio (and/or gas ejection) alarms can be most noticeable to an approaching animal or thing. By way of example only, without restricting the disclosure in any way, the system 100 can include one or more EME transducers 20 comprising: light emitters 25 installed along an outer rim of the door 12 so as to project light vertically up or horizontally as depicted in, for example, FIG. 2; light emitters 25 installed on the body 14 along the rim of the fixed non-movable portion of the appliance 10, for example, flush with the wall or cabinets as depicted in, for example, FIG. 3; or the gas ejector 26 that can supply forced air with gas ejection nozzles installed on the rims of the dropdown door 12 or on the non-moving body 14, for example, a side of the appliance 14 flush with the wall in a way as to blow air at an angle towards the oncoming person.

In certain embodiments, the EME transducer 20 can be affixed or installed to a cabinet or cabinet door to mitigate or resolve the risk of banging one's head or face against a cabinet door. Corner cabinets can particularly benefit from the installation of the EME transducer 20. This is a case where light may be shined towards the floor from the cabinet door or the cabinet.

FIG. 4 shows a block diagram that depicts a nonlimiting embodiment of the obstruction alarm (OA) system 100, constructed according to the principles of the disclosure. The OA system 100 can be included (or installed) in equipment or structures, such as, for example, household appliances (for example, stove, microwave, washer, dryer, etc.), household furniture (for example, cabinets, closets, desks, etc.), industrial appliances (for example, machinery, equipment, etc.), or the like, to prevent accidents and injury. In various embodiments, the OA system 100 includes the alarm controller 30 and one or more EME transducers 20.

Referring to FIGS. 2 and 4, in an embodiment the appliance 10 includes the OA system 100 in which the EME transducers 20 include light emitters 25 (shown in FIG. 5) configured along the perimeter of the door 12 and arranged to emit light beams 15 as seen in FIG. 2.

In another embodiment, referring to FIGS. 3 and 4, the appliance 10 includes the OA system 100 in which the EME transducers 20 include light emitters 25 configured on the body 14 along the perimeter of the door opening housing and arranged to emit light beams as seen in FIG. 3.

In another embodiment, the EME transducer 20 include light emitters 25 configured along both the perimeter of the door 12 and on the body 14 along the perimeter of the door opening, and arranged to emit light beams as seen in both FIGS. 2 and 3, simultaneously, or in alternating patterns (for example, door light emitters 25 turned ON and door-opening light emitters 25 turned OFF, and then door light emitters 25 turned OFF and door-opening light emitters 25 turned ON).

In various embodiments, the EME transducer 20 can include only the sensor unit 24 or only the warning unit 29. In an embodiment, the EME transducer 20 can include only a motion sensor. In another embodiment, the EME transducer can include only the light emitter 25, only the gas ejector 25, only the sound generator unit 27, or only the door position sensor 28.n. In other embodiments, the EME transducer 20 can include any combination of the foregoing.

FIG. 6 shows a block diagram of an embodiment of the alarm controller 30, configured according to the principles of the disclosure. The alarm controller 30 is configured, in various embodiments, to operate as discussed above, including to: receive sensor data; detect or identify a hazardous condition; monitor an area in the vicinity of the hazardous condition; detect and identify animals in the area of the hazardous condition; and predict an animal or a trajectory of any animal in relation to the hazardous condition. The alarm controller 30 is further configured in those embodiments to discern between a hazardous condition and a non-hazardous condition and operate one or more warning devices to generate alarm signals that can alert animals of the hazardous condition. In an embodiment, the controller 30 is configured to send data to a communicating device (not shown) such as a cloud server to build, train, and/or tune one or more ML models on the remote server and download the updated models from the communication device to the controller 30. In an embodiment, the controller 30 is configured to communicate with a further communication device (not shown) such as, for example, a smartphone, a tablet, or other portable computing device.

The controller 30 can include a plurality of computer resource assets, including a bus 105, a processor 110, a memory 120, a communication unit 130, a machine learning (ML) platform suite 140, and a driver suite 150. The communication unit 130 includes an input-output (I/O) interface, a network interface, and one or more transceivers. The ML platform suite 140 includes m ML models (or ML platforms), where m is a positive integer. Any of the computer resources assets 110 to 150 can be interconnected using a bus 105, or various communication links, including buses, and can be mounted on a common motherboard or in another manner, as appropriate.

The processor 110 can be arranged to execute instructions and process data within the controller 30, including instructions stored in the memory 120. The processor 110 can be configured to execute instructions and process data. The processor 110 can be arranged to interact with, or generate and send instruction signals to, for example, the driver suite 150 to control one or more EME transducers 20 (shown in FIG. 4 or 5).

The processor 110 can be configured to communicate over one or more communications link with any of the components 21-28 in the EME transducer 20 (shown in FIG. 5), and/or a control unit in the appliance 10 (such as, for example, a dishwasher electronic control board, a washing machine controller, or the like), and/or a communicating device (not shown) such as, for example, a smartphone, a tablet, or a portable computing device. In some embodiments, the processor 110 is configured to communicate with a mobile app on a smartphone, including receiving instructions from the mobile app and configuring and/or controlling settings of the controller 30 and/or EME transducers 20. In an embodiment, a user can configure settings and/or control operations of the controller 30 via their smartphone, using the mobile app stored locally in the smartphone.

In various embodiments, the EME transducer 20 (shown in FIG. 5) and/or controller 30 (shown in FIG. 6) can be configured to communicate via the communication unit 23 (shown in FIG. 5) and/or communication unit 130 (shown in FIG. 6) with a communicating device (not shown) such as, for example, the control unit in the appliance 10, a cloud server, or a remote computer via one or more communication links. In the case of the appliance control unit (not shown), the communication unit 23 and/or 130 can include, for example, an interface and a serial bus. In certain embodiments, the controller 30 (or the EME transducer 20) is configured as a retrofit device, such as, for example, a dongle, that can be electronically connected to the control unit in the appliance 10. In certain embodiments, the system 100 can be configured as a retrofit device. The EME transducers 20 and controller 30 can be configured to draw power from the equipment or structure in which they are installed.

In at least one embodiment, the system 100 can be built into, or can include EME transducers 20 and/or controller 30 built into, new equipment or structures. The system 100 can be configured to draw power from the same source as the new equipment or structures. For instance, the system 100 can be connected to a power supply line of the new equipment or structures.

In various embodiments, the processor 110 can be configured to execute the instructions and process data to interact with and control an LED driver 150B, a gas driver 150C, or a sound driver 150D, to determine the position of the door 12 in real-time and reproduce light beam signals, gas flow, or sound signals, such as, for example, via the EME transducers 20.

The memory 120 can include a read-only memory (ROM) 120A, a random-access memory (RAM) 120B, and a hard disk drive (HDD) 120C. The memory 120 can provide nonvolatile storage of data, data structures, and computer-executable instructions, and can accommodate the storage of any data in a suitable digital format. The memory 120 can include a computer-readable medium that can hold executable or interpretable computer code (instructions) that, when executed by the processor 110, cause the steps, processes and methods of the various embodiments in this disclosure to be carried out. The computer-readable medium can be contained in the memory 120, and can include sections of computer code that, when executed by the processor 110, cause the controller 30 to monitor an area for moving objects via, for example, the sensor driver 150A, and render an alarm via, for example, the LED driver 150B, gas driver 150C, or sound driver 150D. In some embodiments, sensor data from the sensor unit 24 (shown in FIG. 5) can be processed and analyzed by the processor 110 or ML platform 140 to identify a hazardous/non-hazardous condition and calculate or predict a trajectory of each moving object in the vicinity of the sensor unit 24.

A basic input-output system (BIOS) can be stored in the ROM 120A, which can include, for example, a non-volatile memory, an erasable programmable read-only memory (EPROM), or an electrically erasable programmable read-only memory (EEPROM). The BIOS can contain the basic routines that help to transfer information between any one or more of the computing resource assets in the controller 30 (or system 100), such as during start-up.

The RAM 120B can include, for example, dynamic random-access memory (DRAM), a synchronous dynamic random-access memory (SDRAM), a static random-access memory (SRAM), or a nonvolatile random-access memory (NVRAM) for caching data.

The HDD 120C can include, for example, an enhanced integrated drive electronics (EIDE) drive or any suitable hard disk drive for use with the particular application. The HDD 120C can be configured for external use in a suitable chassis (not shown).

A computer program product can be tangibly embodied in a non-transitory computer-readable medium, which can be contained in the memory 120, or provided as an external computer resource asset and connected to the bus 105. The computer program product can contain instructions that, when executed, perform one or more methods or operations, such as those included in this disclosure.

Any number of computer resources can be stored in the memory 120, including, for example, a program module, an operating system, an application program, an application program interface (API), or program data. The computing resource can include an API such as, for example, a web API, a simple object access protocol (SOAP) API, a remote procedure call (RPC) API, a representation state transfer (REST) API, or any other utility or service API. Any (or all) of the operating system, application programs, APIs, program modules, and program data can be cached in the RAM 120B as executable sections of computer code.

The network interface (shown in FIG. 6) can be connected to a network, such as, for example, a residential, industrial, institutional, or other local area network (LAN), which can connect to the Internet. The network interface can include a wired or a wireless communication network interface (not shown) or a modem (not shown). When used in a LAN, the controller 30 can be connected to the LAN network through the wired or wireless communication network interface; and, when used in a wide area network (WAN), the controller 30 can be connected to the WAN network through the modem. The modem (not shown) can be internal or external and wired or wireless. The modem can be connected to the system bus 105 via, for example, a serial port interface (not shown). The network interface can include a receiver (not shown), a transmitter (not shown) or a transceiver (not shown). The network interface can communicate data and instructions between the controller 30 and a communicating device (not shown) such as, for example, a computer, server, or cloud server.

The input-output (IO) interface (shown in FIG. 6) can receive commands or data from an operator via a user interface (not shown), such as, for example, a keyboard (not shown), a mouse (not shown), a pointer (not shown), a stylus (not shown), a microphone (not shown), a speaker (not shown), or a display device (not shown). The received commands and data can be forwarded from the IO interface as instruction to data signals, via the bus 105, to any of the computer resource assets in the controller 30.

In at least one embodiment, the driver suite 150 includes the sensor driver 150A, the LED driver 150B, the gas driver 150C, and the sound driver 150D. The driver suite 150 can be communicatively coupled to one or more EME transducers 20 (shown in FIG. 5) and configured to receive motion data, image data, and motion detection signals from the sensor unit 24, and, through interactions with the processor 110, including analysis of the sensor data by the processor 110 to detect a hazardous condition and collision trajectory by an object or animal, send data and control signals to the light emitter 25, the gas ejector 26 or the sound generator unit 27.

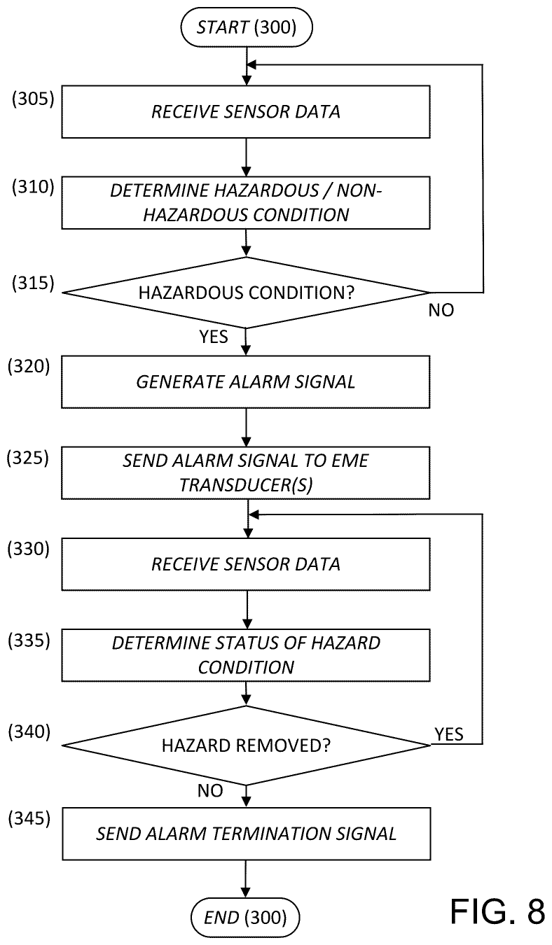

FIG. 7 shows a nonlimiting embodiment of a process 200 for generating an alarm, according to the principles of the disclosure. The process 200 can be performed by the controller 30 (shown in FIG. 6). In at least one embodiment, the controller 30 includes computer program instructions that, when executed by the processor 110, cause the controller 30 to carry out each of the steps of the process 200. The computer program instructions can be stored in a non-transient computer storage medium in the memory 120 (shown in FIG. 6) and accessed and executed by the processor 110.

Referring to FIGS. 5-7 contemporaneously, a door position signal is received from either the door position sensor 28 or the control unit (not shown) of the appliance 10 (Step 205). On the basis of the received door position signal, the processor 110 determines the door position value, such as, for example, the angle θ between a longitudinal axis or surface plane of the door 12 and the gravitational vector, or a longitudinal (or vertical) axis or vertical plane of the appliance 10, which is typically parallel to the gravitational vector (Step 210). A determination is then made based on the door position whether an alarm condition exists based on the determined door position (Step 215).

In certain embodiments, the alarm condition is a one-step alarm condition that is determined by comparing the real-time door position angle θ a predetermined threshold angle θ_{TH}, such that if θ>θ_{TH}, then an alarm condition is determined. The threshold angle θ_{TH} can be set to an angle value, for example, between about 5° and about 90°, such as, θ_{TH}=5°, 10°, 15°, 20°, 25°, 30°, 35°, 40°, 45°, 50°, 55°, 60°, 65°, 70°, 75°, 80°, or greater.

Other threshold angle θ_{TH} values are also contemplated, including a θ_{TH} value greater than 0° and less than 180°, or any value therebetween.

In at least one embodiment, the alarm condition is a two-step alarm condition that, in addition to the one-step alarm condition determination based on the real-time door position, is determined by also monitoring for motion detection signals from the motion sensor unit 24 (shown in FIG. 5), and, when a motion detection signal is received, determining whether the motion detection signal is indicative of motion such as, for example, by a person. In this regard, the motion detection signal received from the motion sensor 24 can be compared against a predetermined threshold value to determine whether the detected motion is that of a person, a small animal, or a noisy environment. The noisy environment can include, for example, heat dissipated by the appliance 10 when the door 12 is opened, which can be detected by the motion sensor unit 24 in certain situations as a motion signal, such as, for example, where the motion sensor unit 24 includes an IR sensor.

If an alarm condition is determined (YES at Step 215), then an alarm signal is generated (Step 220) and sent to the EME transducer 20 (Step 225), otherwise (NO at Step 215) the controller 30 continues to detect any further door position signals (Step 205) and determine any changes in the real-time position of the door (Step 210).

In various embodiments, the generated alarm signal can include a light emission signal, a gas ejection signal, and/or a sound generation signal, which, when received by the EME transducer 20, cause the light emitter 25, gas ejector unit 26, and sound/or sound generator 27 to, respectively, produce one or more light beams, gas ejection streams, and/or sounds.

The controller 30 can continue to monitor and determine the position of the door 12 in real-time by receiving the door position signal from the door position sensor 28 (FIG. 5), or from the controller of the appliance 10, indicative of the real-time position of the door 12 (Step 230) and if the position of the door 12 has changed such that the one-step alarm condition has been removed (YES at Step 240), an alarm termination signal can be sent to the EME transducer 20 (Step 245) to terminate all alarms, otherwise (NO at step 240), the process can return and repeat Steps 230 to 240.

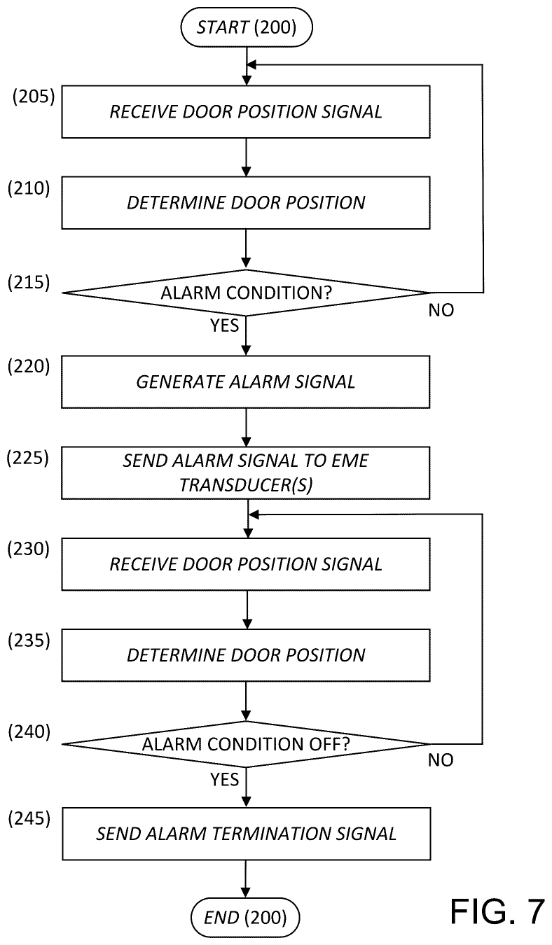

FIG. 8 shows a nonlimiting embodiment of a process 300 for identifying a hazardous condition and generating an alarm, according to the principles of the disclosure. The process 300 can be performed by the controller 30 (shown in FIG. 6). In at least one embodiment, the controller 30 includes computer program instructions that, when executed by the processor 110, cause the controller 30 to carry out each of the steps of the process 300. The computer program instructions can be stored in a non-transient computer storage medium in the memory 120 (shown in FIG. 6) and accessed and executed by the processor 110.

Referring to FIGS. 5, 6 and 8 contemporaneously, sensor data is received by the controller 30 from the sensor unit 24 (Step 305). The sensor data include motion data from the motion sensor 28. 1, image data from the image sensor 28.2, and door position data from the door position sensor 28.n. The sensor data is analyzed by the controller 30 (for example, processor 110 and/or ML platform 140) to detect or identify a hazardous condition (Step 310), such as, for example, an open appliance door that is in the path of an approaching animal.

In distinguishing between a hazardous and non-hazardous condition, the controller 30 (for example, processor 110 and/or ML platform 140) analyzes the sensor data to discern whether a hazardous condition exists (Step 310), for example, by analyzing the infrared (IR) data in the motion data and/or the image data and calculating or predicting a trajectory of the animal with respect to the hazard (for example, open appliance door) and predicting a likelihood score of impact by the animal with the hazard.

If the prediction score exceeds a predetermined threshold (for example, greater than 90% likelihood) the controller 30 can predict a hazardous condition (YES at Step 315) and generate an alarm signal by one or more drivers in the driver suite 150 (Step 320) and send the alarm signal(s) to the EME transducer(s) 20 (Step 325) to output an alarm by emitting light, sound, or pressurized gas.

If, however, the prediction score does not exceed the predetermined threshold (NO at Step 315), then the controller 30 can continue to receive real-time sensor data (305) and analyze the sensor data in real-time (310) to track the motion and trajectory of the animal until a hazardous condition is identified or otherwise determined (YES at Step 315).

After the alarm is triggered (Step 320) and the alarm signal sent to the EME transducer 20 (Step 325), the controller 30 can continue to receive real-time sensor data (Step 330), analyze the sensor data in real-time, and predict or otherwise determine the status of the hazardous condition (Step 335). If it is determined that the hazard has been removed (YES at Step 340), then an alarm termination signal can be sent to the EME transducer(s) 20 to shut off the alarm (Step 345), otherwise (NO at Step 340) the controller 30 can continue receive (Step 330) and analyze real-time sensor data (Step 335) until the hazard is removed (YES at Steep 340). In analyzing the sensor data, the controller 30 can determine whether the hazard has been removed based on, for example, the detected position of an appliance door (for example, whether it has been closed), a change in trajectory or motion of the animal (for example, a person who stops or changes direction) such that the hazard no longer presents a hazardous condition.

The terms “a,” “an,” and “the,” as used in this disclosure, means “one or more,” unless expressly specified otherwise.

The term “bus,” as used in this disclosure, means any of several types of bus structures that can further interconnect to a memory bus (with or without a memory controller), a peripheral bus, or a local bus using any of a variety of commercially available bus architectures.

The term “communicating device” or “communication device,” as used in this disclosure, means any computing device, hardware, or computing resource that can transmit or receive digital or analog signals or data packets, or instruction signals or data signals over a communication link. The device can be portable or stationary.

The term “communication link,” as used in this disclosure, means a wired and/or wireless medium that conveys data or information between at least two points. The wired or wireless medium can include, for example, a metallic conductor link, a radio frequency (RF) communication link, an Infrared (IR) communication link, or an optical communication link. The RF communication link can include, for example, GSM voice calls, SMS, EMS, MMS messaging, CDMA, TDMA, PDC, WCDMA, CDMA2000, GPRS, WiFi, WiMAX, IEEE 802.11, DECT, 0G, 1G, 2G, 3G, 4G, 5G or 6G cellular standards, or Bluetooth. A communication link can include, for example, an RS-232, RS-422, RS-485, or any other suitable interface.

The terms “computer” or “computing device,” as used in this disclosure, means any machine, device, circuit, component, or module, or any system of machines, devices, circuits, components, or modules, which can be capable of manipulating data according to one or more instructions, such as, for example, without limitation, a processor, an application specific integrated circuit (ASIC), a field programmable gate array (FPGA), a microprocessor (μP), a central processing unit (CPU), a graphic processing unit (GPU), a general purpose computer, a super computer, a personal computer, a laptop computer, a palmtop computer, a notebook computer, a smart phone, a mobile phone, a tablet, a desktop computer, a workstation computer, a server, a server farm, a computer cloud, or an array of processors, ASICS, FPGAs, μPs, CPUs, GPUs, general purpose computers, super computers, personal computers, laptop computers, palmtop computers, notebook computers, desktop computers, workstation computers, or servers. A computer or computing device can include hardware, firmware, or software that can transmit or receive data packets or instructions over a communication link. The computer or computing device can be portable or stationary.

The term “computer asset,” as used in this disclosure, means a computer resource, a computing device, a communicating device, or a computer-readable medium.

The term “computer resource,” as used in this disclosure, means software, a software application, a web application, a webpage, a document, a file, a record, an application program(ming) interface (API), web content, a computer application, a computer program, computer code, machine executable instructions, or firmware. A computer resource can include an information resource. A computer resource can include machine instructions for a programmable computing device, and can be implemented in a high-level procedural or object-oriented programming language, or in assembly/machine language.

The term “computer-readable medium,” as used in this disclosure, means any storage medium that participates in providing data (for example, instructions) that can be read by a computer. Such a medium can take many forms, including non-volatile media and volatile media. Non-volatile media can include, for example, optical or magnetic disks and other persistent memory. Volatile media can include dynamic random access memory (DRAM). Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, a carrier wave as described hereinafter, or any other medium from which a computer can read. The computer-readable medium can include a “Cloud,” which includes a distribution of files across multiple (e.g., thousands of) memory caches on multiple (e.g., thousands of) computers. The computer-readable medium can include magnetic discs, optical disks, memory, or Programmable Logic Devices (PLDs).

Various forms of computer readable media can be involved in carrying sequences of instructions to a computer. For example, sequences of instruction (i) can be delivered from a RAM to a processor, (ii) can be carried over a wireless transmission medium, and/or (iii) can be formatted according to numerous formats, standards or protocols, including, for example, WiFi, WiMAX, IEEE 802.11, DECT, 0G, 1G, 2G, 3 G, 4G, or 5G cellular standards, or Bluetooth.

The terms “including,” “comprising” and variations thereof, as used in this disclosure, mean “including, but not limited to,” unless expressly specified otherwise.

The term “network,” as used in this disclosure means, but is not limited to, for example, at least one of a personal area network (PAN), a local area network (LAN), a wireless local area network (WLAN), a campus area network (CAN), a metropolitan area network (MAN), a wide area network (WAN), a metropolitan area network (MAN), a wide area network (WAN), a global area network (GAN), a broadband area network (BAN), a cellular network, a storage-area network (SAN), a system-area network, a passive optical local area network (POLAN), an enterprise private network (EPN), a virtual private network (VPN), the Internet, or any combination of the foregoing, any of which can be configured to communicate data via a wireless and/or a wired communication medium. These networks can run a variety of protocols, including, but not limited to, for example, Ethernet, IP, IPX, TCP, UDP, SPX, IP, IRC, HTTP, FTP, Telnet, SMTP, DNS, ARP, ICMP.

The term “server,” as used in this disclosure, means any combination of software or hardware, including at least one computing resource or at least one computer to perform services for connected communicating devices as part of a client-server architecture. The at least one server application can include, but is not limited to, a computing resource such as, for example, an application program that can accept connections to service requests from communicating devices by sending back responses to the devices. The server can be configured to run the at least one computing resource, often under heavy workloads, unattended, for extended periods of time with minimal or no human direction. The server can include a plurality of computers configured, with the at least one computing resource being divided among the computers depending upon the workload. For example, under light loading, the at least one computing resource can run on a single computer. However, under heavy loading, multiple computers can be required to run the at least one computing resource. The server, or any if its computers, can also be used as a workstation.

The terms “send,” “sent,” “transmission,” or “transmit,” as used in this disclosure, means the conveyance of data, data packets, computer instructions, or any other digital or analog information via electricity, acoustic waves, light waves or other electromagnetic emissions, such as those generated with communications in the radio frequency (RF) or infrared (IR) spectra. Transmission media for such transmissions can include coaxial cables, copper wire and fiber optics, including the wires that comprise a system bus coupled to the processor.

Devices that are in communication with each other need not be in continuous communication with each other, unless expressly specified otherwise. In addition, devices that are in communication with each other may communicate directly or indirectly through one or more intermediaries.

Although process steps, method steps, algorithms, or the like, may be described in a sequential or a parallel order, such processes, methods and algorithms may be configured to work in alternate orders. In other words, any sequence or order of steps that may be described in a sequential order does not necessarily indicate a requirement that the steps be performed in that order; some steps may be performed simultaneously. Similarly, if a sequence or order of steps is described in a parallel (or simultaneous) order, such steps can be performed in a sequential order. The steps of the processes, methods or algorithms described herein may be performed in any order practical.

When a single device or article is described herein, it will be readily apparent that more than one device or article may be used in place of a single device or article. Similarly, where more than one device or article is described herein, it will be readily apparent that a single device or article may be used in place of the more than one device or article. The functionality or the features of a device may be alternatively embodied by one or more other devices which are not explicitly described as having such functionality or features.

The subject matter described above is provided by way of illustration only and should not be construed as limiting. Various modifications and changes can be made to the subject matter described herein without following the example embodiments and applications illustrated and described, and without departing from the true spirit and scope of the invention encompassed by the present disclosure, which is defined by the set of recitations in the following claims and by structures and functions or steps which are equivalent to these recitations.

What is claimed is:

1. A system for rendering an alarm signal when a hazardous condition is detected, the system comprising:
a sensor unit configured to detect an animal or a moving object and output sensor data;
a controller configured to
receive the sensor data,
analyze, by one or more machine learning platforms, the sensor data, and
predict a hazardous condition based on the analysis of the sensor data; and
a warning unit configured to render an alarm signal in response to the predicted hazardous condition.

2. The system of claim 1, wherein the sensor unit comprises a sensor configured to detect a hazard and output second sensor data,
wherein the controller is further configured to
receive the second sensor data,
analyze the second sensor data, and
predict the hazardous condition based on said sensor data and the second sensor data.

3. The system of claim 2, wherein the sensor unit comprises a door position sensor and the hazard is an appliance door.

4. The system of claim 1, wherein the controller is configured to calculate or predict a trajectory of the animal or the moving object.

5. The system of claim 1, wherein the controller is configured to
receive real-time sensor data from said sensor unit,
analyze, by the one or more machine learning platforms, the real-time sensor data, and
update the calculated or predicted trajectory of the animal or the moving object based on the analysis of the real-time sensor data.

6. The system of claim 5, wherein the controller is configured to determine whether the hazardous condition is removed based on the updated trajectory of the animal or the moving object.

7. The system of claim 1, wherein the sensor unit comprises at least one of an infrared (IR) sensor, an image sensor, and a door position sensor.

8. The system of claim 1, wherein the system is further configured to save battery energy by operating only one sensor in the sensor unit before analyzing any sensor data or predicting the hazardous condition.

9. The system of claim 8, wherein the only one sensor comprises a motion sensor.

10. The system of claim 4, wherein the one or more machine learning platforms are configured to recognize a behavior pattern in the calculated or predicted trajectory of the animal or the moving object and predict a non-hazardous condition based on the behavior pattern.

11. The system of claim 10, wherein the behavior pattern comprises at least one of:
movement corresponding to loading or unloading an appliance or a machine;
movement corresponding to closing a door of an appliance or a machine; and
movement corresponding to manipulating and removing a hazard.

12. The system of claim 1, further comprising:
a communication unit configured to
(a) send parametric data to a communicating device and receive either (i) updated parametric data to tune the one or more machine learning platforms or (ii) updated one or more machine learning platforms; or
(b) communicate with a mobile app on a smartphone, a tablet, or another communicating device, wherein the system comprises the mobile app.

13. The system of claim 1, wherein the warning unit comprises at least one of
a light emitter,
a gas ejector, and
a sound generator.

14. The system of claim 7, wherein controller comprises a driver configured to generate electronic signals to adjust or control at least one of:
the infrared (IR) sensor;
the image sensor;
the door position sensor;
a light emitter;
a gas ejector; and
a sound generator.

15. The system of claim 1, wherein the one or more machine learning platforms include a deep learning model configured to recognize the animal or the moving object.

16. The system of claim 1, wherein the sensor unit includes an accelerometer or gyro sensor.

17. The system of claim 1, wherein the system is constructed as an integrated device.

18. The system of claim 17, wherein the integrated device comprises a system-on-a-chip.

19. A computer-implemented method for rendering an alarm signal when a hazardous condition is detected, the method comprising:
receiving, by a controller, sensor data from at least one of a motion sensor, an image sensor, and a door position sensor;
analyzing, by one or more machine learning platforms, the sensor data to predict a hazardous condition;
predicting, by the one or more machine learning platforms, the hazardous condition; and
sending, by the controller, one or more alarm signals to a warning unit based on the precited hazardous condition.

20. The computer-implemented method of claim 19, wherein the warning unit includes at least one of:
a light emitter;
a gas ejector; and
a sound generator.
